(19) United States
(12) Patent Application Publication
(10) Pub. No.: US 2016/0285348 A1
(43) Pub. Date: Sep. 29, 2016

(54) SYSTEM AND APPARATUS FOR MOVING A ROTOR RELATIVE TO A GENERATOR

(71) Applicant: GENERAL ELECTRIC COMPANY, Schenectady, NY (US)

(72) Inventors: Adrian Adam Klejc, Siedlce (PL); Wiktor Wojciechowski, Pszenno (PL); David Rothwell Burgoon, Sussex, NJ (US)

(21) Appl. No.: 15/036,697

(22) PCT Filed: Nov. 13, 2013
(86) PCT No.: PCT/PL2013/000145

§ 371 Date: May 13, 2016

(51) Int. Cl. H02K 15/00

(52) U.S. Cl. CPC H02K 15/0006

(57) ABSTRACT

A system and an apparatus that can stabilize the rotor in the generator to restrict rotation as the rotor moves longitudinally relative to the generator (and stator) during repair and maintenance. The system and apparatus includes structures that engage one another, thus avoiding potential conditions that can cause the rotor to rotate. The structures also couple a force along the center axis of the rotor to further alleviate imbalances that can arise during the longitudinal movement of the rotor.

### BACKGROUND OF THE INVENTION

The subject matter disclosed herein relates to generators and repair and maintenance of the same, and, in particular, to embodiments of a system and an apparatus that restrict rotational movement of a rotor (or “field generator”) during movement of the rotor, e.g., relative to a gas turbine generator.

Generators include a stator and a rotor that rotates relative to the stator to generate electricity. Technicians often need to remove the rotor from the stator to perform repair and maintenance on the generator. In conventional practice, this task requires overhead cranes and rigging in combination with certain implements (e.g., field support shoes and core skid pans) to guide and support the rotor during removal from the generator. The configuration of the rigging, however, is not typically standardized. Rather, the construction of the generator and the experience and know-how of the technicians that are to complete the repair and maintenance ultimately determine the way the rigging secures to the rotor.

The rigging often engages the rotor at points that are radially outside of the center axis of the rotor. This engagement directs the pulling forces off-center from the center axis of the rotor when moving the rotor relative to the stator. The resulting offset may cause the rotor to become unstable during removal and, in some cases, prone to rotational movement (e.g., rolling). Such rotational movement can shift the weight of the rotor off of the field support shoes that are meant to prevent contact between the rotor and the stator or other elements of the generator. In some cases, the resulting moment of inertia can cause inadvertent contact between the rotor and the stator, which can lead to extensive damage, requiring substantial repair and machine downtime.

The discussion above is merely provided for general background information and is not intended to be used as an aid in determining the scope of the claimed subject matter.

### BRIEF DESCRIPTION OF THE INVENTION

The disclosure below describes embodiments of a system and an apparatus that can stabilize the rotor in the generator to restrict rotation as the rotor moves longitudinally relative to the generator (and stator) during repair and maintenance. These embodiments incorporate structures that engage one another, thus avoiding potential conditions that can cause the rotor to rotate. The structures also couple a force along the center axis of the rotor to further alleviate imbalances that can arise during the longitudinal movement of the rotor.

The disclosure describes, in one embodiment, a system for moving a rotor relative to a generator. The system includes a pull plate with a center pull plate axis and a force coupler for receiving a load, the force coupler securing to the pull plate and aligning with the center pull plate axis. The system further includes a first alignment member with a longitudinal axis that aligns with the center pull plate axis of the pull plate and a second alignment member with an opening for receiving the first alignment member. The system also includes an engagement structure disposed on the first alignment member and the second alignment member, the engagement structure configured to restrict relative rotational movement between the first alignment member and the second alignment member.

The disclosure also describes, in one embodiment, a system for moving a rotor from a stator in a generator. The system includes a tubular member with a longitudinal axis that aligns with a center axis of the rotor, a plate comprising an opening for receiving the tubular member, a support structure secured to the plate to align the opening in the plate with the tubular member, and an engagement structure comprising a pair of rib members and a pair of channels that engage the pair of rib members to restrict relative rotational movement between the tubular member and the plate.

The disclosure further describes, in one embodiment, an apparatus for moving a rotor relative to a stator in a generator. The apparatus includes a plate comprising an opening and a pair of channels formed integrally with the opening, a pair of vertical alignment members disposed on either side of the plate, the pair of vertical alignment members affixing the plate to align a center axis of the opening with a center axis of the rotor, and a base structure supporting the pair of vertical alignment members, the base structure comprising one or more load bearing members that contact a platform proximate the generator.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which;

FIG. 1 depicts a schematic diagram of a side, exploded assembly view of an exemplary embodiment of a system for moving a rotor relative to a generator;

FIG. 2 depicts the system of FIG. 1 in assembled form with the rotor in a first position;

FIG. 3 depicts the system of FIG. I in assembled form with the rotor in a second position that is spaced apart from the first position of FIG. 2,

FIG. 4 depicts a schematic diagram of a perspective view of an exemplary embodiment of a system for moving a rotor relative to a generator;

FIG. 5 depicts a schematic diagram of a front, elevation view of an exemplary embodiment of a system for moving a rotor relative to a generator;

FIG. 6 depicts a side, partial cross section of the system of FIG. 5; and

FIG. 7 depicts a perspective view of an exemplary embodiment of a system for moving a rotor relative to a generator.

### DETAILED DESCRIPTION OF THE INVENTION

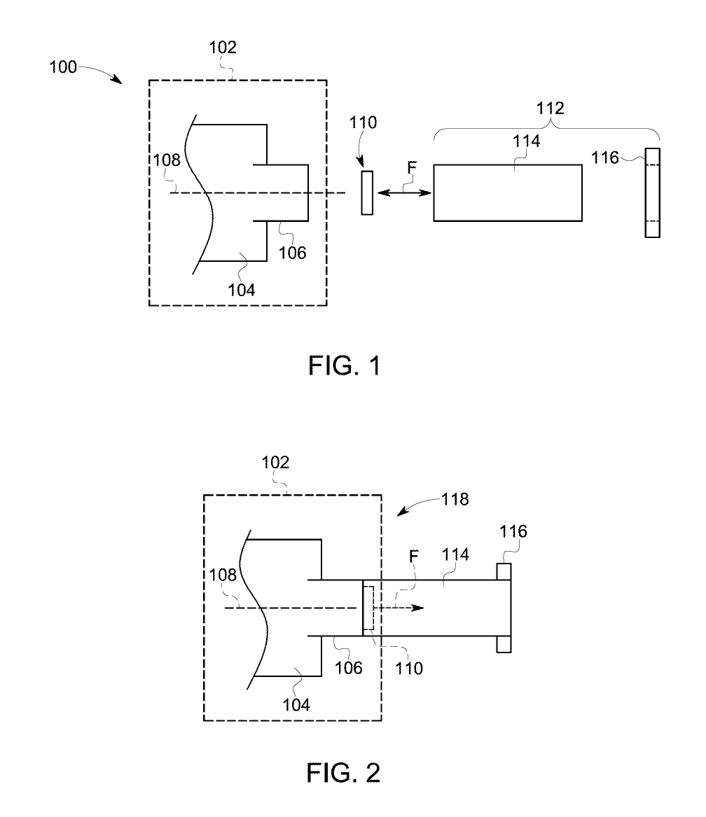

FIG. 1 depicts a schematic diagram that illustrates a side, elevation view of an exemplary embodiment of a system 100 in exploded assembly form. The system 100 is useful to facilitate repair and maintenance of power generating equipment (e.g., a turbine generator 102 with a stator 104 and a rotor 106 that has a center rotor axis 108). As discussed more below, the system 100 couples with the rotor 106 to restrict rotation of the rotor 106 as technicians move the rotor 106 longitudinally relative to the stator 104. This feature prevents damage that may result it for example, the rotor 106 rotates in a manner that causes inadvertent contact with the stator 104 or other structures of the generator 102, Because of the size and weight of the rotor 106, any contact may damage the rotor 106 or the stator 104 beyond repair and, ultimately, result in substantial costs for repairs and for the time the generator 102 is unable to generate power.

As shown in FIG. 1, embodiments of the system 100 may include one or more components that work together to move the rotor 106 relative to the generator 102. These embodiments can include a force-directing component 110 and an alignment component 112 that includes a first alignment member 114 and a second alignment member 116. The force-directing component 110 secures to the rotor 106 to couple a force F to translate the rotor 106 relative to the stator 104. The alignment component 112 is configured to counter-act rotation of the rotor 106 that can occur during translation due, at least in part, to the design and construction of the rotor 106.

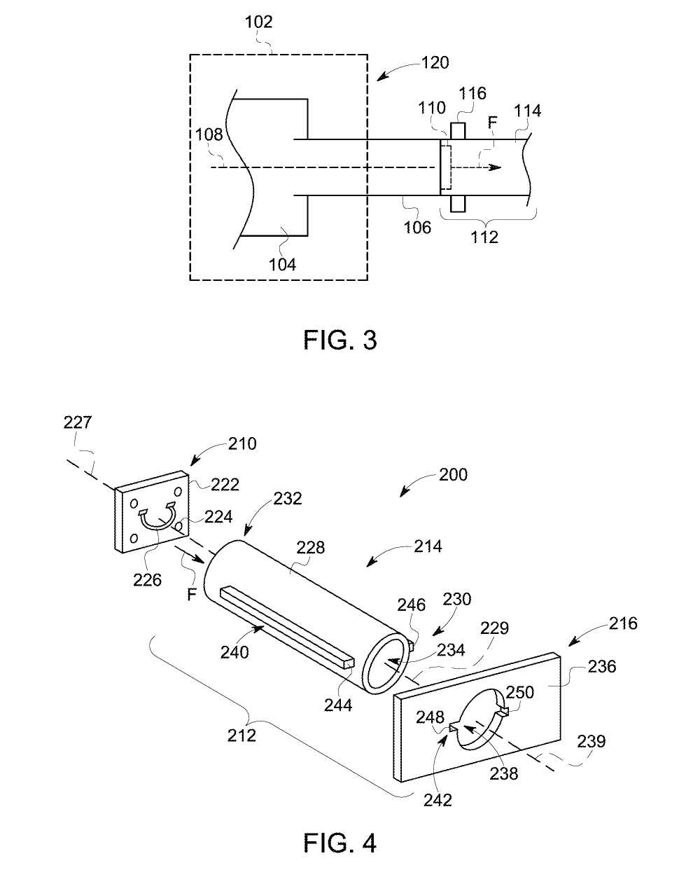

FIGS. 2 and 3 illustrate an exemplary implementation of the system 100 to help stabilize the rotor 106 as the rotor 106 moves longitudinally between a plurality of positions. In FIG. 2, the rotor 106 resides in a first position 118, which may coincide with the position of the rotor 106 when rotating inside of the stator 104 during operation. The force-directing component 110 secures to the rotor 106 to direct the force F along the center rotor axis 108. Aligning the force F in this manner couples the force F at the effective center-of-gravity of the rotor 106 to prevent the force F from inducing rotation of the rotor 106, either alone or in combination with one or more other contributing factors (e.g., misalignment or misapplication of conventional removal aids and devices, improper or inappropriate techniques and procedures, etc.). In one implementation, the first alignment member 114 can couple with the rotor 106, e.g., via direct coupling with the rotor 106 or indirect coupling by way of the force-directing component 110. The second alignment member 116 resides in a location that is spaced apart from the generator 102, but that can still engage the first alignment member 114 to stabilize the rotor 106 during longitudinal translation.

As shown in FIG. 3, the rotor 106 can assume a second position 120 in which the end of the rotor 106 is moved relative to the stator 104 to allow technicians to perform repair and maintenance. The second position 120 locates the end of the rotor 106 spaced apart from the first position 118 (FIG. 2) and, generally, from the generator 102. In one implementation, the alignment component 112 assumes a configuration that affixes the location of the second alignment member 116 relative to the generator 102. This configuration affords the system 100 with certain favorable features. For example, as noted herein, the system 100 utilizes the engagement of the first alignment member 114 and the second alignment member 116 to maintain the radial position of the rotor 106 in the second position 120, e.g., during translation from the first position 118 (FIG. 2) to the second position 120, and vice versa. This engagement restricts rotational movement of the rotor 106, which in turn helps to avoid damaging the rotor 106 as the first alignment member 114 (and the rotor 106) moves longitudinally relative to the second alignment member 116. The system 100 can also utilize the structure of the second alignment member 116 to support the weight of the rotor 106. In other implementations, the system 100 may include one or more additional structures that support the weight of the rotor 106 in the second position 120. Examples of these additional structures include blocking and framing that direct loading downward (e.g., onto a platform), slings and related rigging that hang from a suitably configured overhead crane, and like implements that provide support at one or more locations of the rotor 106.

FIG. 4 depicts a schematic diagram of a perspective view of an exemplary embodiment of a system 200 to illustrate elements that restrict rotation of the rotor (e.g., rotor 106 of FIGS. 1, 2, and 3) during translation. In FIG. 4, the force-directing component 210 comprises a pull plate 222 with a plurality of mounting openings 224 and a force coupler 226 disposed thereon and aligned with a center pull plate axis 227. The first alignment member 214 has an elongated body 228 with a longitudinal axis 229, a first end 230, and a second end 232. In one example, the elongated body 228 can secure to the rotor 106 (FIGS. 1-3) or the pull plate 222 at the second end 232 to restrict relative rotation between the force-generating component 210 and the first alignment member 214 during movement of the rotor 106 (FIGS. 1-3).

The elongated body 228 forms an interior bore 234 that terminates at openings on both the first end 230 and the second end 232. The second alignment member 216 includes an alignment plate 236 with an alignment opening 238 having a center axis 239 and geometry that can receive the elongated body 228 therein. As also shown in FIG. 4, the alignment component 212 includes an engagement structure that restricts the rotational movement of the elongated body 228 relative to the alignment plate 236. This engagement structure can include one or more engagement elements (e.g., a first engagement member 240 and a second engagement member 242) that reside on one of the alignment members 214, 216. In the present example of FIG. 4, the first engagement member 240 forms one or more rib elements (e.g., a first rib member 244 and a second rib member 246). The second engagement member 242 includes one or more channels (e.g., a first channel 248 and a second channel 250) that integrate with the alignment opening 238 on the alignment plate 236. Examples of the channels 248, 250 form features that penetrate the surface of the material of the alignment plate 236, e.g., a square or rectangular groove having a bottom and opposing side walls or a slit.

During implementation of the system 200, the rib members 244, 246 align with the channels 248, 250. Application of force F on the pull plate 222 causes the elongated body 228 and the rib members 244, 246 to transit through, respectively, the alignment opening 238 and the channels 248, 250. Slight rotation of the rotor (e.g., rotor 106 of FIGS. 1-3) in either direction (e.g., clockwise direction or counter-clockwise direction) will cause rotation of the elongated body 228. This rotation causes the rib members 244, 246 to contact surfaces of the channels 248, 250. which restricts rotation of the elongated body 228. For example, contact between the rib members 244, 246 and the surfaces of the channels 248, 250 negates excessive radial shifts in the weight of the rotor that might otherwise result in uncontrolled rotational movement that can damage the rotor.

The engagement structure can assume various configurations to restrict rotation of the elongated body 228. Generally, the rib members 244, 246 and the channels 248, 250 can be disposed about the periphery of respectively, the elongated body 228 and the alignment opening 238. In FIG. 4, the first rib member 244 and the second rib member 246 (and, accordingly, the first channel 248 and the second channel 250) are diametrically opposite from one another, wherein the first rib member 244 is offset from the second rib member 246 by 180°. In other examples, however, the first rib member 244 and the second rib member 246 (and, accordingly, the first channel 248 and the second channel 250) can be offset from one another at varying degrees (e.g., 90°, 270°, etc.) about the periphery of the corresponding structure.

The rib members 244, 246 may include one or more protruding elements (or “bosses”) that protrude from the exterior surface of the elongated body 228. As shown in the diagram of FIG. 4, the protruding elements can extend as a unitary unit axially along the elongated body 228. Other configurations may utilize a plurality of smaller units for the protruding elements that populate the axial length of the elongated body 228. These smaller units may reside in close proximity to one another or abut adjacent elements. In other examples, construction of the protruding elements that uses these smaller units may incorporate a gap between the adjacent units. The size of the gap may be devised as desired to restrict rotation of the rotor as contemplated herein. The protruding elements may be formed integrally with the body 228, e.g., as might be the case when fabricating the elongated body 228 using extrusion or molding techniques. In other examples, the protruding elements may be separate pieces that affix to the elongated body 228, e.g., by way of bolts, screws, and like fasteners, as well as by way of welds, adhesives, and similar fastening techniques. In one embodiment, the rib members 244, 246 may reside on the alignment plate 236 in lieu of the channels 248, 250. This configuration of the rib members 244, 246 can engage corresponding. channels on the elongated body 228. In one example, the alignment plate 236 may include one or more hardened steel pins that protrude into the alignment opening 238 to engage slotted features of the elongated body 228.

Examples of the elongated body 228 may form a tubular member with an effective hollow center (e.g., interior bore 234). This tubular member may have a generally circular shape, although this disclosure does contemplate the use of other shapes (e.g., square, rectangular, etc.) that can provide the necessary functions as well. Composition of the tubular member can comprise metals (e.g., steel) and materials that afford the tubular member with sufficient strength, rigidity, and performance characteristics for use with the effective size and weight of the rotor. Selected construction may also enhance one or more of these characteristics of the tubular member to accommodate for changes in the distribution of forces on the system 200. For example, the tubular member must counteract increases in torque and moment forces that occur as the rotor extends out and away from the generator and, in particular, that occur when the rotor is at its farthest possible extended position.

The pull plate 222 secures to the rotor to direct force F centrally along the center axis of the rotor. This feature can prevent the force F from inducing rotation of the rotor during removal, alone or in combination with other factors as noted or contemplated herein. Examples of the openings 224 in the pull plate 222 can include enlarged cylindrical holes, elongated slots, and combinations thereof. Enlarged holes or elongated slots provide a larger target opening, as compared to cylindrical holes. This size difference can accommodate varying tolerances, misalignment, and differences in orientation that technicians may encounter during implementation of the embodiments disclosed herein. Fasteners can extend through the openings 224 to couple with corresponding threaded holes on the rotor. Examples of suitable fasteners include bolts and pins, although this disclosure contemplates a wide range of standard and customary fasteners with properties that can couple the pull plate 222 with the rotor under high loading necessary to move the rotor longitudinally relative to the stator.

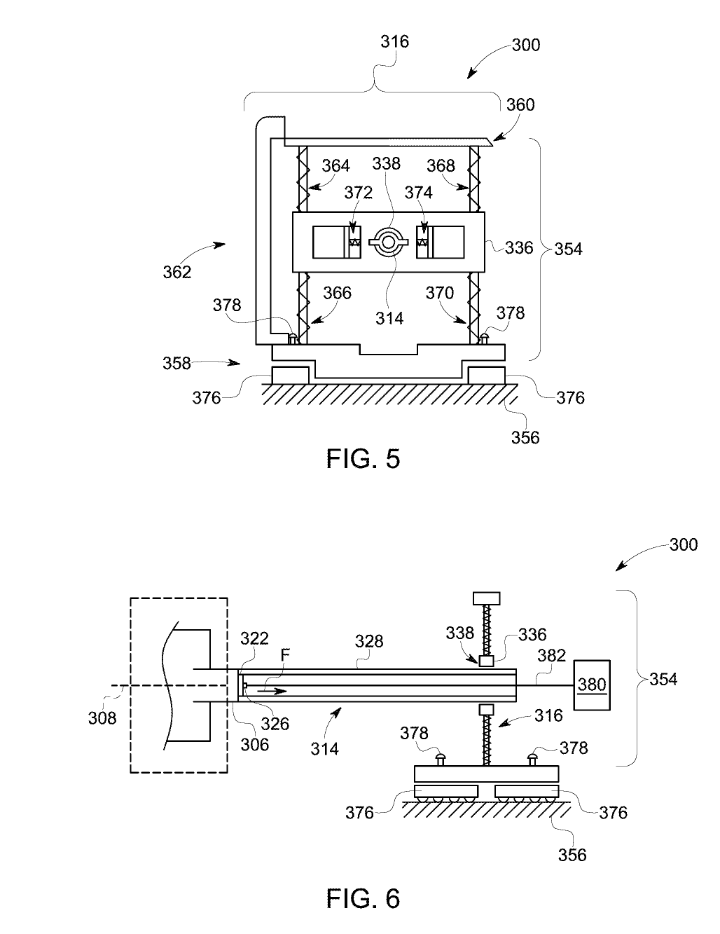

FIGS. 5 and 6 illustrate a schematic diagram of, respectively, a front, elevation view (FIG. 5) and a side, cross-section view (FIG. 6) of an exemplary embodiment of a system 300 for use to move a rotor relative to a generator. These diagrams provide details for one configuration of the second alignment member 316. This configuration permits the position of the alignment features on the second alignment member 316 to adjust, e.g., vertically or horizontally, to accommodate for relative misalignment between the structures of the system and the stator of the generator.

100301 In the example of FIG. 5, the second alignment member 316 has a frame structure 354 that sits on a platform 356. Examples of the platform 356 include structural platforms constructed temporarily (or permanently) in position, as well as floor and bases (e.g., cement or concrete floors) found in locations that utilize large, turbine generators. The frame structure 354 includes a base structure 358, a top structure 360, and an upright structure 362. The frame structure 354 can also incorporate various alignment structures that can help maintain or modify the position of the plate 336 relative to one or more other elements of the frame structure 354. These alignment structures can include one or more vertical alignment structures (e.g., a first vertical alignment structure 364, a second vertical alignment structure 366, a third vertical alignment structure 368, and a fourth vertical alignment structure 370) and one or more horizontal alignment structures (e.g., a first horizontal alignment structure 372 and a second horizontal alignment structure 374). The base structure 358 can include one or more load bearing members 376 and one or more leveling devices 378.

Construction of the frame structure 354 can utilize manufacturing techniques that are known to provide secure connection of elements and meet the desired strength characteristics for equipment of this type. For example, the base structure 358, the top structure 360, and the upright structure 362 can take the form of one or more weldments (e.g., a welded frame) or like construction that use welds to secure one or more elements (e.g., the plate 336 and the alignment structures 364. 366, 368, 370) together. This disclosure contemplates materials that include metal (e.g., steel) tubes and plates of selected dimensions (e.g., thickness) and arrangements deemed appropriate for purposes of carrying loads.

The base structure 358 incorporates features that stabilize the second alignment member 316 to counteract forces that the rotor may induce in the other elements of the system 300. These features can afford the base structure 358 with a wide base to position the load bearing members 376 a sufficient distance apart to restrict rolling of the second alignment member 316 during removal. Examples of the load bearing members 376 incorporate devices (e.g., castors, wheels, sliders, bearings, etc.) that support loads and facilitate movement of the second alignment member 316, e.g., over surfaces of platform 356. In one implementation, the load bearing member 376 permits the second alignment member 316 to translate concurrently with first alignment member 314 during removal (and insertion) of the rotor.

Use of the leveling devices 378 change the position of the plate 336, thus helping to align the opening 338 in the plate with the first alignment member 314 during set up of the system 300. The leveling devices 378 can include bolts (also “jacking bolts”). These bolts can rotate, e.g., via manual interaction, to raise and lower the plate 336 relative to the loading bearing members 376. Other devices for the leveling devices 378 include pneumatic devices and like devices that do not require the end user to interact with the device to change the position of the plate 336.

Like the leveling devices 378, examples of the various alignment structures (e.g., vertical alignment structures 364, 366, 368, 370 and horizontal alignment structures 372, 374) afford the plate 336 with degrees of freedom to facilitate alignment and set-up of the system 300. These alignment structures can incorporate jacking bolts that the end user interacts with to change the position of the plate 336. In other embodiments, the alignment structures can incorporate passive devices, e.g., springs and spring members, that can deflect under loading. Still other embodiments can utilize active devices, e.g., pneumatic cylinders and lead screws, that the end user can actuate to change the position of the plate 336. This disclosure also contemplates configurations of the system 300 that incorporate one or more of these devices (e.g., manual, passive, active) together to facilitate alignment of the plate 336.

As shown in FIG. 6, examples of the frame structure 354 locate the plate 336 in position to align the opening 338 with the center rotor axis 308. This position allows the elongated body 328 to transit through the opening 338 to allow for longitudinal movement of the rotor 306. The hollow center of the elongated body 328 affords access to the force coupler 326 to affix a loading mechanism 380 that generates the force F. In the present example of FIG. 6, the system 300 also includes a coupling member 382, which extends from the loading mechanism 380 through the elongated body 328 to couple with the force coupler 326. This configuration affixes the load to the rotor 306. Examples of the force coupler 336 can include a hoist ring or a hitch, although this disclosure recognizes that a variety of configuration of devices and structures can be used to couple the loading mechanism. The coupling member 382 may include a rope, chain, or cable that can thread into and through the hollow center of the elongated body 328. This rope/chain/cable can terminate in a hook or like device that can engage with the force coupler 326. Examples of the loading mechanism 380 may further include a winch or pulley system that can apply a load onto the rope/cable, thus transmitting the force F to the force coupler 326.

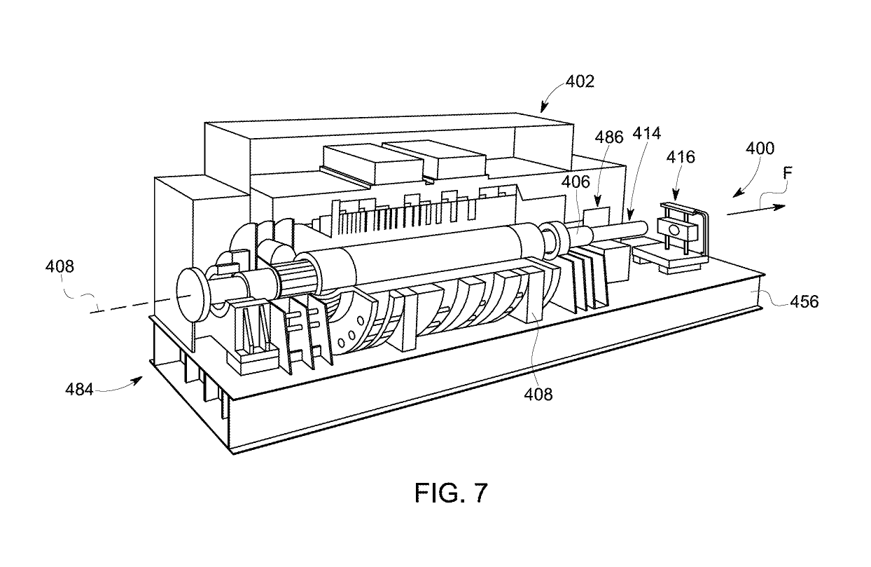

FIG. 7 illustrates a perspective view of an exemplary embodiment of a system 400 in position on the structural platform 456 that abuts the generator 402. The rotor 406 has a driver end 484 and a collector end 486. On the driver end 484, the rotor 406 can mate with a gas or steam turbine or other power generating equipment that rotates the rotor 406 relative to the stator 404. During repair and maintenance, technicians can secure the first alignment member 414 to the rotor 404 at the collector end 486. The technicians can also position the second alignment member 416 in at a location to receive the end of the first alignment member 414. Transmitting the force F to the rotor 406 along the center rotor axis 408 changes the position of the rotor 406 in relation to the stator 404. For example, application of the force F as a pulling force can remove the rotor 406 from the stator 404 to expose portions of the generator 402 for technicians to perform repair and maintenance tasks. Use of the force F can also return the rotor 406 back into position inside of the stator 404. In one example, application of the force F as a pushing force on the collector end 486 can position the rotor 406 in the stator 404 to bring the generator 402 back on-line. Technical procedures for repair and maintenance of most generators 402, however, are likely to apply the force F as a pulling force on the driver end 484. This technique can translate the rotor 406 through the stator 406.

In view of the foregoing, this disclosure herein contemplates, in various embodiments, structures that are useful to avoid damage to the rotor of a generator during repair and maintenance. These embodiments can prevent significant rotational movement of the rotor as the rotor translates relative to the stator. This feature maintains alignment of the rotor, thus reducing the likelihood that imbalances in loading and other factors will cause the rotor to shift position during removal and, consequently, cause significant damage to the rotor.

As used herein, an element, member, or function recited in the singular and proceeded with the word “a” or “an” should be understood as not excluding plural said elements, members, or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for moving a rotor relative to a generator, comprising:
a pull plate with a center pull plate axis and a force coupler for receiving a load, the force coupler securing to the pull plate and aligning with the center pull plate axis;
a first alignment member with a longitudinal axis that aligns with the center pull plate axis of the pull plate;
a second alignment member with an opening for receiving the first alignment member; and
an engagement structure disposed on the first alignment member and the second alignment member, the engagement structure configured to restrict relative rotational movement between the first alignment member and the second alignment member.

2. The system of claim I, wherein the engagement structure comprises a first rib member and a second rib member and a pair of channels for receiving the first rib member and the second rib member.

3. The system of claim 2, wherein the first rib member and the second rib member are disposed on the first alignment member and the pair of channels are formed integrally with the opening on the second alignment member.

4. The system of claim 2, wherein the first rib member and the second rib member are disposed on the second alignment member extend into the opening in the second alignment member and the pair of channels extend longitudinally along the first alignment member.

5. The system of claim 1, wherein the first alignment member comprises a tubular member having an interior bore that forms openings on both ends of the tubular member.

6. The system of claim 5, further comprising a coupling member that extends through the interior bore, the coupling member having an end that secures to the force coupler.

7. The system of claim 5, wherein the pull plate fits inside of the interior bore.

8. The system of claim 1, wherein the second alignment member comprises a frame structure having one or more vertical alignment structures configured to adjust the position of the opening of the second alignment member relative to the first alignment member.

9. The system of claim 8, wherein the frame structure comprises one or more horizontal alignment structures disposed orthogonal to the vertical alignment structures, and wherein the horizontal alignment structures are configured to adjust the position of the opening of the second alignment member relative to the first alignment member.

10. The system of claim 8, wherein the frame structure is configured to affix the second alignment member in a location that is spaced apart from the rotor.

11. The system of claim 1, wherein the pull plate is configured to couple with the rotor.

12. The system of claim 1, wherein the first alignment member is configured to couple with the pull plate.

13. The system of claim 1, further comprising one or more load bearing members secured to the second alignment member, wherein the loading bearing members are spaced apart from one another a distance that restricts roll of the second alignment member.

14. The system of claim 1, wherein the pull plate is configured to secure to the rotor to align the force coupler with a center axis of the rotor.

15. A system for moving a rotor relative to a stator in a generator, the system comprising:
a tubular member with a longitudinal axis that aligns with a center axis of the rotor;
a plate comprising an opening for receiving the tubular member;
a support structure secured to the plate to align the opening in the plate with the tubular member; and
an engagement structure comprising a pair of rib members and a pair of channels that engage the pair of rib members to restrict relative rotational movement between the tubular member and the plate.

16. The system of claim 15, wherein the pair of rib members are disposed on the tubular member and the pair of channels are disposed on the plate.

17. An apparatus for moving a rotor relative to a stator in a generator, the apparatus comprising:
a plate comprising an opening and a pair of channels formed integrally with the opening;
a pair of vertical alignment members disposed on either side of the plate, the pair of vertical alignment members affixing the plate to align a center axis of the opening with a center axis of the rotor; and
a base structure supporting the pair of vertical alignment members, the base structure comprising one or more load bearing members that contact a platform proximate the generator.

18. The apparatus of claim 17, wherein the load bearing members comprise one or more rollers.

19. The apparatus of claim 17, wherein the vertical alignment members comprise a shaft that extends through the plate and one or more springs disposed on the shaft.

20. The apparatus of claim 17, wherein the vertical alignment members comprise one or more actuators.
